(19) United States
(12) Patent Application Publication
(10) Pub. No.: US 2022/0373316 A1
(43) Pub. Date: Nov. 24, 2022

(54) SURFACE TEXTURE MEASURING MACHINE AND SURFACE TEXTURE JUDGMENT METHOD

(71) Applicant: MITUTOYO CORPORATION, Kawasaki (JP)

(72) Inventor: Hiroomi HONDA, Miyazaki (JP)

(73) Assignee: MITUTOYO CORPORATION, Kawasaki (JP)

(21) Appl. No.: 17/750,939

(22) Filed: May 23, 2022

(30) Foreign Application Priority Data
May 24, 2021 (JP) 2021-086836

(51) Int. Cl. G01B 5/28

(52) U.S. Cl. CPC G01B 5/28

(57) ABSTRACT

A surface texture measuring machine includes: a parameter setting unit configured to set one or more parameters related to a surface texture of a workpiece; a measurement unit configured to calculate a measurement value corresponding to each of the parameters on the basis of displacement measurement data obtainable by scanning a surface of the workpiece or a master workpiece; a judgment value calculation unit configured to calculate a judgment value corresponding to each of the parameters with an assumption that the measurement value of the master workpiece is defined as a reference value and a value having a predetermined ratio relative to the reference value is defined as a tolerance; and a judgment unit configured to compare the measurement value of the workpiece and the judgment value for each of the parameters.

The entire disclosure of Japanese Patent Application No. 2021-086836 filed May 24, 2021 is expressly incorporated by reference herein.

### TECHNICAL FIELD

The present invention relates to a surface texture measuring machine and a surface texture judgment method.

### BACKGROUND ART

A known typical surface texture measuring machine measures a surface texture (e.g., surface roughness) of a workpiece. For instance, a surface texture measuring machine disclosed in Patent Literature 1 (JP 2000-227329 A), which includes a stylus that is to be brought into contact with a workpiece surface, acquires displacement measurement data indicating unevenness of the workpiece surface by scanning the surface of the workpiece with the stylus.

The above-described surface texture measuring machine calculates measurement values of a variety of parameters related to the surface texture from the acquired displacement measurement data. For instance, a height-direction parameter Ra, which is referred to as “arithmetic mean roughness”, is calculated as an average value of unevenness within a reference length of a scanning range, whereas a height-direction parameter Ry, which is referred to as “maximum height”, is calculated as the sum of a maximum peak height Rp and a maximum valley height Rv within the reference length of the scanning range.

In addition, for the purpose of quality control of a workpiece or the like, the above-described surface texture measuring machine performs pass/fail judgment of the surface texture of the workpiece in some cases. For the pass/fail judgment, one or more parameters are set as judgment items and a judgment value corresponding to each of the parameters is set. The judgment value is a value given by adding a tolerance, or acceptable error, to a reference value. For instance, a value given by adding an upper tolerance limit (a positive tolerance) to the reference value of the parameter is an upper-limit judgment value, whereas a value given by adding a lower tolerance limit (a negative tolerance) to the reference value of the parameter is a lower-limit judgment value.

However, in setting the judgment value, the above-described surface texture measuring machine requires a tolerance of a parameter to be inputted by a measurer operation, so that the measurer has to do a cumbersome setting work prior to the start of judgment. In particular, in a case where a plurality of parameters are used as judgment items, a tolerance needs to be inputted for each of the parameters, which makes the setting work more cumbersome with a required time prior to the start of judgment increased.

### SUMMARY OF THE INVENTION

An object of the invention is to provide a surface texture measuring machine and a surface texture judgment method that allow for reducing a setting work for judging a surface texture of a workpiece.

A surface texture measuring machine according to an aspect of the invention includes: a parameter setting unit configured to set one or more parameters related to a surface texture of a workpiece; a measurement unit configured to calculate a measurement value corresponding to each of the parameters on the basis of displacement measurement data obtainable by scanning a surface of the workpiece or a master workpiece; a judgment value calculation unit configured to calculate a judgment value corresponding to each of the parameters with an assumption that the measurement value of the master workpiece is defined as a reference value and a value having a predetermined ratio relative to the reference value is defined as a tolerance; and a judgment unit configured to compare the measurement value of the workpiece and the judgment value for each of the parameters.

In the surface texture measuring machine according to the aspect of the invention, the judgment value or values of the one or more parameters related to the surface texture of the workpiece are calculated on the basis of the displacement measurement data obtainable by scanning the master workpiece. This eliminates the necessity of an operation to input a tolerance of each parameter, allowing for reducing a setting work for judging the surface texture of the workpiece. In particular, in a case where a large number of parameters are used, the setting work can be considerably reduced and a required time prior to the start of judgment can be saved.

In the surface texture measuring machine according the aspect of the invention, in a case where a first parameter and a second parameter different from each other are set as the parameters, the judgment value calculation unit is configured to calculate the judgment value corresponding to the first parameter and the judgment value corresponding to the second parameter by using values different from each other as the ratio.

By virtue of such a configuration, a suitable judgment value to each of the first parameter and the second parameter is calculated in accordance with characteristics of the parameter.

A surface texture measuring machine according to another aspect of the invention includes: a parameter setting unit configured to set one or more parameters related to a surface texture of at least one workpiece; a measurement unit configured to calculate a measurement value corresponding to each of the parameters on the basis of displacement measurement data obtainable by scanning a surface of the workpiece; a judgment value calculation unit configured to calculate a judgment value corresponding to each of the parameters with an assumption that an average value of the measurement values of the plurality of workpieces is defined as a reference value and a value having a predetermined ratio relative to the reference value is defined as a tolerance; and a judgment unit configured to compare the measurement value of the workpiece and the judgment value for each of the parameters.

In the surface texture measuring machine according to the above aspect of the invention, the judgment value or values of the one or more parameters related to the surface texture of the workpiece are calculated on the basis of the displacement measurement data obtainable by scanning the plurality of workpieces. This eliminates the necessity of an operation to input a tolerance of each parameter, allowing for reducing a setting work for judging the surface texture of the workpiece. In particular, in a case where a large number of parameters are used, the setting work can be considerably reduced and a required time prior to the start of judgment can be saved.

In the surface texture measuring machine according to the above aspect of the invention, in a case where a first parameter and a second parameter different from each other are set as the parameters, the judgment value calculation unit is configured to calculate the judgment value corresponding to the first parameter and the judgment value corresponding to the second parameter by using values different from each other as the ratio.

By virtue of such a configuration, a suitable tolerance to each of the first parameter and the second parameter can be set in accordance with characteristics of the parameter.

A surface texture judgment method according to still another aspect of the invention is a method that is to be performed in a surface texture measuring machine configured to measure a surface texture of a workpiece, the method including: setting one or more parameters related to the surface texture of the workpiece; calculating a measurement value corresponding to each of the parameters on the basis of displacement measurement data obtainable by scanning a surface of a master workpiece; calculating a judgment value corresponding to each of the parameters with an assumption that the measurement value of the master workpiece is defined as a reference value and a value having a predetermined ratio relative to the reference value is defined as a tolerance; calculating a measurement value corresponding to each of the parameters on the basis of displacement measurement data obtainable by scanning a surface of the workpiece; and comparing the measurement value of the workpiece and the judgment value for each of the parameters.

In addition, a surface texture judgment method according to a further aspect of the invention is a method that is to be performed in a surface texture measuring machine configured to measure a surface texture of at least one workpiece, the method including: setting one or more parameters related to the surface texture of the workpiece; calculating a measurement value corresponding to each of the parameters on the basis of displacement measurement data obtainable by scanning a surface of the workpiece; calculating a judgment value corresponding to each of the parameters with an assumption that an average value of the measurement values of the plurality of workpieces is defined as a reference value and a value having a predetermined ratio relative to the reference value is defined as a tolerance; and comparing the measurement value of the workpiece and the judgment value for each of the parameters.

The above-described surface texture judgment methods both eliminate the necessity of an operation to input a tolerance of each parameter, allowing for reducing a setting work for judging the surface texture of the workpiece.

### BRIEF DESCRIPTION OF DRAWINGS

FIG. 1 is a perspective view of an appearance of a surface texture measuring machine according to a first exemplary embodiment of the invention.

FIG. 2 schematically illustrates the surface texture measuring machine according to the first exemplary embodiment.

FIG. 3 is a block diagram illustrating a control unit of the surface texture measuring machine according to the first exemplary embodiment.

FIG. 4 is a flowchart for explaining a workpiece surface texture judgment method according to the first exemplary embodiment.

FIG. 5 is a flowchart for explaining a workpiece surface texture judgment method according to a second exemplary embodiment of the invention.

### DESCRIPTION OF EMBODIMENT(S) n

### First Exemplary Embodiment

Description will be made below on a surface texture measuring machine according to a first exemplary embodiment of the invention with reference to the attached drawings.

### Outline of Configuration of Surface Texture Measuring Machine

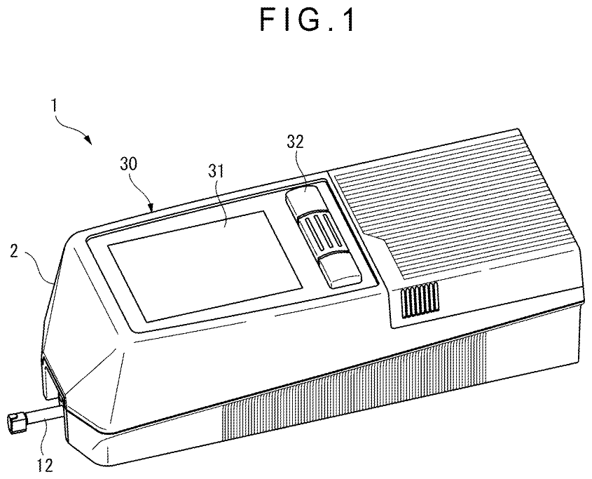

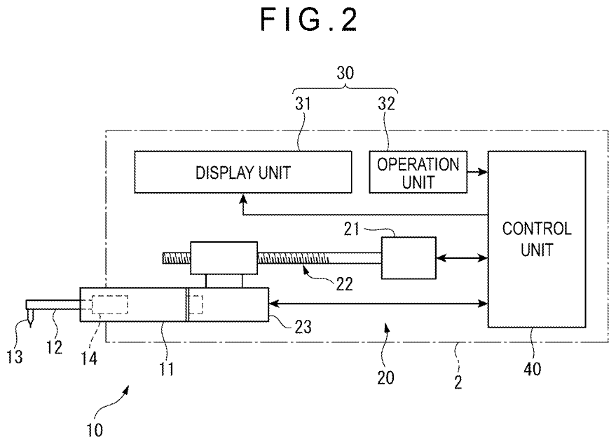

FIG. 1 is a perspective view of an appearance of a surface texture measuring machine 1 of this exemplary embodiment and FIG. 2 is an internal mechanism of the surface texture measuring machine 1.

The surface texture measuring machine 1 of this exemplary embodiment includes a detector 10 that detects a displacement of a measurement target, i.e., a workpiece surface, a drive unit 20 that causes the detector 10 to move, a user interface 30, and a control unit 40 that performs a variety of controls. It should be noted that the surface texture measuring machine 1 described by way of example in this exemplary embodiment is a handheld measuring machine, further including a case 2 where the detector 10, the drive unit 20, and the control unit 40 are integrally housed.

The detector 10 includes a detector body 11 held by the drive unit 20, a stylus arm 12 swingably supported by the detector body 11, a stylus 13 projecting from a distal end of the stylus arm 12, and a detection unit 14 that detects a swinging amount of a base end of the stylus arm 12.

During a movement of the stylus 13 along a workpiece surface, a surface texture (for instance, surface roughness) of the workpiece surface causes the stylus 13 to move up and down. The up-and-down motion of the stylus 13 is detectable as a detection signal by the detection unit 14.

The drive unit 20 includes a motor 21 fixed to the case 2, a lead screw mechanism 22 coupled to the motor 21, and a holding member 23 that is to be transferred in a measurement direction by the lead screw mechanism 22. The holding member 23 holds the above-described detector body 11. In addition, the lead screw mechanism 22 may be equipped with an encoder for detecting a movement amount of the holding member 23 in the measurement direction.

The user interface 30 includes a display unit 31 that displays a variety of information and an operation unit 32 that receives an input operation from a user. The operation unit 32 may be in the form of an operation button located on a surface of the case 2 or a touch display provided with the display unit 31.

It should be noted that the display unit 31 and the operation unit 32 are arranged on a front surface portion of the case 2 in this exemplary embodiment but it is not limiting. For instance, the surface texture measuring machine 1 may be connected to a terminal device for communication so that a variety of information is displayed by a display unit provided in the terminal device or an input operation from a user is received by an operation unit provided in the terminal device.

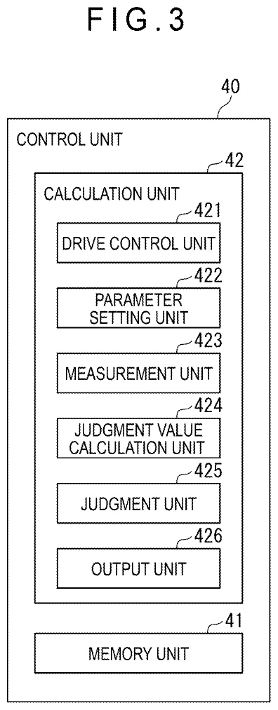

The control unit 40, which includes a computer, controls the detector 10 and the drive unit 20. The control unit 40 includes a memory unit 41 including a memory or the like and a calculation unit 42 including a CPU (Central Processing Unit) or the like as illustrated in FIG. 3.

In addition, the calculation unit 42 reads and executes a program stored in the memory unit 41, thereby functioning as a drive control unit 421, a parameter setting unit 422, a measurement unit 423, a judgment value calculation unit 424, a judgment unit 425, and an output unit 426.

The drive control unit 421 controls the drive unit 20, thereby controlling a movement of the detector 10 in the measurement direction to cause the stylus 13 to scan a workpiece surface.

The parameter setting unit 422 sets, as a parameter related to a surface texture of a workpiece, one or more parameters, which are judgment items for pass/fail judgment on the workpiece.

The measurement unit 423 acquires a detection signal outputted from the detector 10 at a predetermined sampling interval, thereby acquiring displacement measurement data regarding the workpiece surface within a scanning range. Then, the measurement unit 423 calculates a measurement value corresponding to the parameter (hereinafter, referred to as parameter measurement value) on the basis of the displacement measurement data.

The judgment value calculation unit 424 calculates a judgment value corresponding to the parameter (hereinafter, referred to as parameter judgment value) on the basis of a parameter measurement value of a master workpiece.

The judgment unit 425 compares the parameter judgment value calculated by the judgment value calculation unit 424 and the parameter measurement value calculated by the measurement unit 423, thereby determining pass/fail on a parameter-by-parameter basis. In addition, the judgment unit 425 performs pass/fail judgment on the workpiece on the basis of a parameter-based pass/fail result.

The output unit 426 causes the display unit 31 to display the parameter measurement value calculated by the measurement unit 423, the pass/fail result determined by the judgment unit 425, and the like.

The memory unit 41 stores a program for causing the calculation unit 42 to operate, a plurality of pieces of parameter information, and the like. The parameter information, which is stored, for instance, on a parameter-by-parameter basis, includes an arithmetic expression for calculating a parameter measurement value, a tolerance ratio (corresponding to a predetermined ratio in the invention) for calculating a parameter judgment value, and the like. Here, assuming that the parameter measurement value of the master workpiece is a reference value, the tolerance ratio refers to a ratio of a tolerance relative to the reference value and is expressed as, for instance, a decimal equal to or smaller than one.

### Workpiece Surface Texture Judgment Method

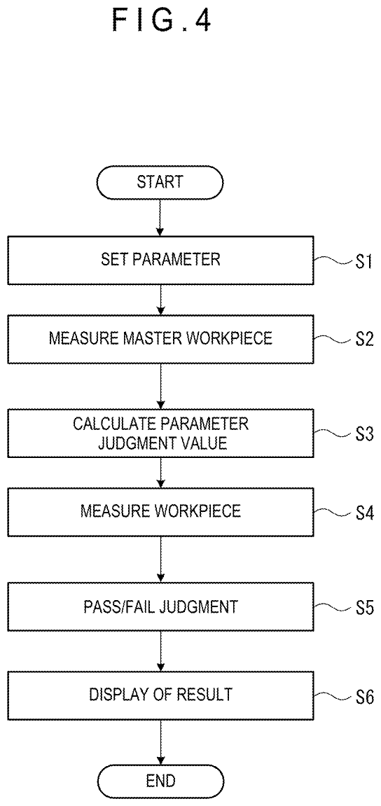

Description will be made on a surface texture judgment method of this exemplary embodiment with reference to a flowchart in FIG. 4.

First, as advance preparation, a measurer selects one or more parameters, which are judgment items for a surface texture of a workpiece, by operating the surface texture measuring machine 1. At this time, the measurer may select which one of an upper-limit judgment value and a lower-limit judgment value is to be used (or both are to be used) or, alternatively, the upper-limit judgment value and the lower-limit judgment value may already be selected as default.

The parameter setting unit 422 sets the parameters by causing the memory unit 41 to store the parameters selected by the measurer as the judgment items (Step S1; Parameter Setting Step).

For the sake of explanation, a case where a parameter Ra (a first parameter) and a parameter Ry (a second parameter) are set as the parameters will be described by way of example below. The parameter Ra is an arithmetic mean roughness of a surface roughness and the parameter Ra is a maximum height of the surface roughness.

Next, the measurer sets a master workpiece with respect to the surface texture measuring machine 1 and performs an operation for starting measurement. This causes the drive control unit 421 and the measurement unit 423 to perform measurement of the master workpiece (Step S2; Master Workpiece Measurement Step).

In Step S2, the drive control unit 421 causes the detector 10 to travel a predetermined distance in the measurement direction at a predetermined scanning speed, and the measurement unit 423 takes a detection signal outputted from the detector 10 at the predetermined sampling interval and causes the memory unit 41 to store the detection signal as displacement measurement data within the scanning range. The measurement unit 423 then calculates, on the basis of the displacement measurement data of the master workpiece, respective measurement values (parameter measurement values MRa, MRy) of the parameters Ra, Ry set in Step S1.

Next, the judgment value calculation unit 424 calculates, on the basis of the parameter measurement values MRa, MRy of the master workpiece measured in Step S2 and tolerance ratios PRa, PRy of the parameters Ra, Ry stored in the memory unit 41, respective judgment values (parameter judgment values ARa, ARy) of the parameters Ra, Ry (Step S3; Judgment Value Calculation Step). It should be noted that the parameter judgment values ARa, ARy each only have to be at least either the upper-limit judgment value or the lower-limit judgment value.

For instance, the judgment value calculation unit 424 can calculate an upper-limit parameter judgment value ARa_{H} and a lower-limit parameter judgment value ARa_{L} by performing calculations of Expressions (1), (2) below, respectively.

$${ARa}_{H} = MRa + MRa \cdot PRa = MRa ( 1 + PRa ) \qquad Expression ( 1 )$$

$${ARa}_{L} = MRa - MRa \cdot PRa = MRa ( 1 - PRa ) \qquad Expression ( 2 )$$

It should be noted that in above-described Expressions (1), (2), “the parameter measurement value MRa of the master workpiece” corresponds to the reference value of the parameter Ra, “a value given by multiplying the parameter measurement value MRa of the master workpiece by the tolerance ratio PRa” corresponds to an upper tolerance limit, and “a value given by multiplying the parameter measurement value MRa of the master workpiece by the tolerance ratio PRa and adding a negative sign thereto” corresponds to a lower tolerance limit.

In other words, according to above-described Expressions (1), (2), the upper-limit parameter judgment value is calculated by adding the upper tolerance limit (a positive tolerance) to the parameter reference value and the lower-limit parameter judgment value is calculated by adding the lower tolerance limit (a negative tolerance) to the parameter reference value.

A method of calculation of the parameter judgment value ARy is similar to the method of calculation of the parameter judgment value ARa described by way of example above.

However, it is favorable that the tolerance ratio PRa corresponding to the parameter Ra and the tolerance ratio PRy corresponding to the parameter Ry are different values from each other.

Specifically, the parameter Ry representing the maximum height of the surface roughness tends to vary widely as compared with the parameter Ra representing the arithmetic mean roughness. Accordingly, it is favorable that the tolerance ratio PRy (e.g., 0.10) corresponding to the parameter Ry is larger than the tolerance ratio PRa (e.g., 0.02) corresponding to the parameter Ra.

Next, the measurer sets a workpiece with respect to the surface texture measuring machine 1 and performs an operation for starting measurement. This causes the drive control unit 421 and the measurement unit 423 to perform measurement of the workpiece (Step S4; Workpiece Measurement Step).

Step S4 is performed similarly to Step S2 described above. In other words, the drive control unit 421 causes the detector 10 to travel the predetermined distance in the measurement direction at the predetermined scanning speed, and the measurement unit 423 takes a detection signal outputted from the detector 10 at the predetermined sampling interval and causes the memory unit 41 to store the detection signal as displacement measurement data within the scanning range. The measurement unit 423 calculates parameter measurement values MRa, MRy on the basis of the displacement measurement data of the workpiece.

Next, the judgment unit 425 performs pass/fail judgment of a surface texture of the workpiece measured in Step S4 (Step S5; Judgment Step).

For instance, in terms of the parameter Ra, the judgment unit 425 compares the parameter judgment values ARa_{H}, ARa_{L} calculated in Step S3 and the parameter measurement value MRa of the workpiece calculated in Step S4. Then, in response to satisfying ARa_{L}≤MRa≤ARa_{H}, pass is determined and, otherwise, fail is determined.

Similarly, in terms of the parameter Ry, the judgment unit 425 compares the parameter judgment values ARy_{H}, ARy_{L} calculated in Step S3 and the parameter measurement value MRy of the workpiece calculated in Step S4. Then, in response to satisfying ARy_{L}≤MRy≤ARy_{H}, pass is determined and, otherwise, fail is determined.

Then, in response to determination of pass in terms of both of the parameters Ra, Ry, the judgment unit 425 judges the surface texture of the workpiece as pass and, otherwise, as fail.

Subsequently, the output unit 426 causes the display unit 31 to display the parameter measurement values MRa, MRy of the workpiece calculated in Step S4, the respective judgment results in terms of the parameters Ra, Ry and the judgment result of the workpiece in Step S5, etc. (Step S6).

The flow in FIG. 4 is terminated in this manner. Subsequently, the measurer sets workpieces in sequence, allowing the surface texture measuring machine 1 to perform above-described Steps S4 to S6 on each workpiece. Here, the parameter judgment values ARa, ARy calculated in above-described Step S3 are usable for the judgment of the surface texture of each workpiece.

### Effects of First Exemplary Embodiment

The surface texture measuring machine 1 of this exemplary embodiment includes the control unit 40 including the memory unit 41 and the calculation unit 42, the calculation unit 42 reading and executing a program stored in the memory unit 41, thereby functioning as the parameter setting unit 422, the measurement unit 423, the judgment value calculation unit 424, and the judgment unit 425 as described above.

According to this exemplary embodiment as above, one or more parameter judgment values related to a surface texture of a workpiece are calculated on the basis of displacement measurement data obtainable by scanning a master workpiece. This eliminates the necessity of an operation to input a tolerance of each parameter, allowing for reducing a setting work for judging the surface texture of the workpiece. In particular, in a case where a large number of parameters are used, the setting work can be considerably reduced and a required time prior to the start of judgment can be saved.

In addition, according to this exemplary embodiment, even in a case where the type of workpiece is changed, it is sufficient that the master workpiece is scanned without the necessity of an operation to change a tolerance in accordance with the type of workpiece. This also makes it possible to reduce a burden on an operator in judging surface textures of a variety of types of workpieces.

In this exemplary embodiment, in a case where parameters different from each other (e.g., the parameters Ra, Ry) are set as the parameters related to the surface texture of the workpiece, the judgment value calculation unit 424 uses the tolerance ratios PRa, PRy different in value from each other between the parameters Ra, Ry to calculate the parameter judgment values ARa, ARy.

According to this exemplary embodiment as above, the respective suitable parameter judgment values ARa, ARy are calculated for the parameters Ra, Ry in accordance with characteristics of the parameters Ra, Ry, which makes it possible to improve judgment accuracy.

### Second Exemplary Embodiment

Next, description will be made on a second exemplary embodiment of the invention. This exemplary embodiment is different from the first exemplary embodiment in that a plurality of workpieces are used to calculate a parameter judgment value instead of the master workpiece. In addition, in this exemplary embodiment, a plurality of machined workpieces subjected to the same machining using the same processing machine are used as the plurality of workpieces.

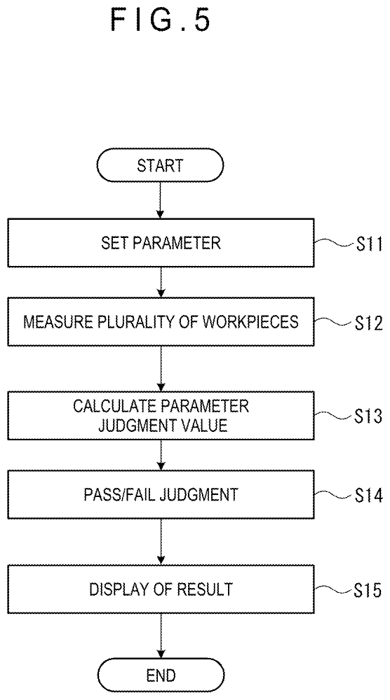

The surface texture judgment method of this exemplary embodiment will be described with reference to a flowchart in FIG. 5.

First, the parameter setting unit 422 sets a parameter in accordance with a measurer selection as in Step S1 of the first exemplary embodiment (Step S11, Parameter Setting Step).

For the sake of explanation, a case where a parameter Ra (a first parameter) and a parameter Ry (a second parameter) are set as the parameters will be described as an example below.

Next, the measurer sets the plurality of workpieces in sequence with respect to the surface texture measuring machine 1 and the surface texture measuring machine 1 measures each of the plurality of workpieces (Step S12; Workpiece Measurement Step). The workpieces being measured in Step S12 are, among the plurality of workpieces subjected to the same machining by the same processing machine, a freely selected number (e.g., N) of the workpieces selected in order starting with the first machined one. Thus, the respective parameter measurement values MRa, MRy of the N workpieces are calculated in Step S12.

Next, the judgment value calculation unit 424 calculates the parameter judgment values ARa, ARy on the basis of the respective parameter measurement values MRa, MRy of the workpieces measured in Step S12 and the tolerance ratios PRa, PRy of the parameters Ra, Ry stored in the memory unit 41 (Step S13; Judgment Value Calculation Step).

For instance, the judgment value calculation unit 424 can calculate an upper-limit parameter judgment value ARa_{H} and a lower-limit parameter judgment value ARa_{L} by performing calculations of Expressions (3), (4) below, respectively.

$${ARa}_{H} = μ Ra + μ Ra \cdot PRa = μ Ra ( 1 + PRa ) \qquad Expression ( 3 )$$

$${ARa}_{L} = μ Ra - μ Ra \cdot PRa = μ Ra ( 1 - PRa ) \qquad Expression ( 4 )$$

It should be noted that μRa in Expressions (3), (4) above denotes an average value of the parameter measurement values MRa of the N workpieces. It means that “the average value μRa of the parameter measurement values MRa of the N workpieces” corresponds to a reference value of the parameter Ra in this exemplary embodiment. In addition, “a value given by multiplying the average value μRa by the tolerance ratio PRa” corresponds to an upper tolerance limit and “a value given by multiplying the average value μRa by the tolerance ratio PRa and adding a negative sign thereto” corresponds to a lower tolerance limit.

In addition, a method of calculation of the parameter judgment value ARy is similar to the method of calculation of the parameter judgment value ARa described by way of example above.

However, it is favorable that the tolerance ratio PRa corresponding to the parameter Ra and the tolerance ratio PRy corresponding to the parameter Ry are values different from each other as in the first exemplary embodiment.

Next, the judgment unit 425 performs pass/fail judgment of the surface texture of each of the N workpieces measured in Step S12 (Step S14; Judgment Step).

It should be noted that the judgment on each workpiece in Step S14 is similar to Step S5 of the first exemplary embodiment. In other words, the judgment unit 425 compares the parameter judgment values ARa, ARy and the parameter measurement values MRa, MRy, thereby determining pass/fail in terms of each of the parameters Ra, Ry and judging, on the basis of respective pass/fail results in terms of the parameters Ra, Ry, whether the surface texture of the workpiece passes or fails.

Subsequently, the output unit 426 causes the display unit 31 to display the parameter measurement values MRa, MRy of each of the workpieces calculated in

Step S12, the respective judgment results in terms of the parameters Ra, Ry and the judgment results of the workpieces in Step S14, etc. (Step S15).

The flow in FIG. 5 is terminated in this manner. Subsequently, the measurer may set workpieces other than the workpieces measured in Step S12 in sequence, causing the surface texture measuring machine 1 to perform the pass/fail judgment on each of the workpieces. Here, the parameter judgment values ARa, ARy calculated in Step S13 described above are usable for the pass/fail judgment on the workpieces.

### Effects of Second Exemplary Embodiment

The surface texture measuring machine 1 of this exemplary embodiment achieves effects similar to those of the first exemplary embodiment. In addition, in this exemplary embodiment, the workpieces, i.e., targets to be judged, are measured to calculate the parameter judgment values ARa, ARy instead of the master workpiece, which makes it possible to save time required for measurement of the master workpiece as compared with the first exemplary embodiment.

It should be noted that in this exemplary embodiment, a plurality of workpieces selected in order starting with the first machined one are measured so that the workpieces machined before a cutting performance of the processing machine deteriorates, i.e., while the processing machine is in a normal operation, are measured. This allows for ensuring judgment accuracy.

### Modification of Second Exemplary Embodiment

In the second exemplary embodiment, the judgment value calculation unit 424 may use a standard deviation of either one of the parameter measurement values MRa, MRy measured in Step S12 to further calculate a judgment value for management for managing a machining accuracy of the processing machine.

For instance, the judgment value calculation unit 424 can calculate an upper-limit judgment value for management BRa_{H} and a lower-limit judgment value for management BRa_{L} by performing calculations of Expressions (5), (6) below, respectively. It should be noted that SRa denotes the standard deviation of the parameter measurement value MRa.

BRa_{H}=μRa+SRa Expression (5)

BRa_{L}=μRa−SRa Expression (6)

Further, the judgment unit 425 may compare the parameter measurement value MRa of another workpiece to be measured after termination of the flow in FIG. 5 and the judgment value for management BRa (the upper-limit judgment value for management BRa_{H}, the lower-limit judgment value for management BRa_{L}).

Assuming that the parameter measurement values MRa of the workpieces are normally distributed, a probability of satisfying BRa_{L}≤MRa≤BRa_{H} (a ratio of pass) is 68%. However, a deterioration of the processing machine, such as a reduction in sharpness of a tool, leads to an increase in unevenness of the surface roughness of a machined surface of the workpiece with the probability of satisfying BRa_{L}≤MRa≤BRa_{H} reduced.

Accordingly, the judgment unit 425 may monitor a change in the probability of satisfying BRa_{L}≤MRa≤BRa_{H} (the ratio of pass) among the measured workpieces in addition to performing the pass/fail judgment on the workpieces. In response to the ratio of pass reaching a predetermined level or below, the output unit 426 may cause the display unit 31 to display a warning indicating a deterioration of the processing machine, or the like.

Such a modification allows a measurer to know a deterioration state of the processing machine before failed workpieces are increased.

### Other Modifications

The invention is not limited to the above-described exemplary embodiments, and modifications and the like are within the scope of the invention as long as an object of the invention is achievable.

For instance, in the above-described exemplary embodiments, the judgment value calculation unit 424 calculates the upper-limit parameter judgment values ARa_{H}, ARy_{H} and the lower-limit parameter judgment values ARa_{L}, ARy_{L}; however, the judgment value calculation unit 424 may calculate either one of the parameter judgment values.

In this case, the judgment unit 425 can determine pass in terms of the parameter Ra in a case where the parameter measurement value MRa is equal to or smaller than the upper-limit parameter judgment value ARa_{H} or in a case where the parameter measurement value MRa is equal to or larger than the lower-limit parameter judgment value ARa_{L}. The same applies to the parameter Ry.

In the above-described exemplary embodiments, the parameters that are judgment items for the surface texture of a workpiece are exemplified by the parameters Ra, Ry; however, the invention is not limited thereto and any number and type of parameters are usable.

In addition, in the above-described exemplary embodiments, the tolerance ratio for calculating the parameter judgment value is stored corresponding to each of the parameters; however, the tolerance ratio may be common to a plurality of parameters.

Although being exemplified by the handheld surface texture measuring machine 1 as illustrated in FIG. 1 in the above-described exemplary embodiments, the surface texture measuring machine of the invention may be a large-sized measuring device placed on a mount with the detector 10 being movably supported by a portal column, an articulated arm, or the like.

What is claimed is:

1. A surface texture measuring machine comprising:
a parameter setting unit configured to set one or more parameters related to a surface texture of a workpiece;
a measurement unit configured to calculate a measurement value corresponding to each of the parameters on a basis of displacement measurement data obtainable by scanning a surface of the workpiece or a master workpiece;
a judgment value calculation unit configured to calculate a judgment value corresponding to each of the parameters with an assumption that the measurement value of the master workpiece is defined as a reference value and a value having a predetermined ratio relative to the reference value is defined as a tolerance; and
a judgment unit configured to compare the measurement value of the workpiece and the judgment value for each of the parameters.

2. The surface texture measuring machine according to claim 1, wherein
in a case where a first parameter and a second parameter different from each other are set as the parameters, the judgment value calculation unit is configured to calculate the judgment value corresponding to the first parameter and the judgment value corresponding to the second parameter by using values different from each other as the ratio.

3. A surface texture measuring machine comprising:
a parameter setting unit configured to set one or more parameters related to a surface texture of at least one workpiece;
a measurement unit configured to calculate a measurement value corresponding to each of the parameters on a basis of displacement measurement data obtainable by scanning a surface of the workpiece;
a judgment value calculation unit configured to calculate a judgment value corresponding to each of the parameters with an assumption that an average value of the measurement values of the plurality of workpieces is defined as a reference value and a value having a predetermined ratio relative to the reference value is defined as a tolerance; and
a judgment unit configured to compare the measurement value of the workpiece and the judgment value for each of the parameters.

4. The surface texture measuring machine according to claim 3, wherein
in a case where a first parameter and a second parameter different from each other are set as the parameters, the judgment value calculation unit is configured to calculate the judgment value corresponding to the first parameter and the judgment value corresponding to the second parameter by using values different from each other as the ratio.

5. A surface texture judgment method that is to be performed in a surface texture measuring machine configured to measure a surface texture of a workpiece, the method comprising:
setting one or more parameters related to the surface texture of the workpiece;
calculating a measurement value corresponding to each of the parameters on a basis of displacement measurement data obtainable by scanning a surface of a master workpiece;
calculating a judgment value corresponding to each of the parameters with an assumption that the measurement value of the master workpiece is defined as a reference value and a value having a predetermined ratio relative to the reference value is defined as a tolerance;
calculating a measurement value corresponding to each of the parameters on a basis of displacement measurement data obtainable by scanning a surface of the workpiece; and
comparing the measurement value of the workpiece and the judgment value for each of the parameters.

6. A surface texture judgment method that is to be performed in a surface texture measuring machine configured to measure a surface texture of at least one workpiece, the method comprising:
setting one or more parameters related to the surface texture of the workpiece;
calculating a measurement value corresponding to each of the parameters on a basis of displacement measurement data obtainable by scanning a surface of the workpiece;
calculating a judgment value corresponding to each of the parameters with an assumption that an average value of the measurement values of the plurality of workpieces is defined as a reference value and a value having a predetermined ratio relative to the reference value is defined as a tolerance; and
comparing the measurement value of the workpiece and the judgment value for each of the parameters.
